(19) United States
(12) Patent Application Publication
(10) Pub. No.: US 2026/0007175 A1
(43) Pub. Date: Jan. 8, 2026

(54) METHOD OF OPERATING AN AEROSOL GENERATOR

(71) Applicant: NICOVENTURES TRADING LIMITED, London (GB)

(72) Inventors: Michael THOMAS, London (GB); Andrew SUTTON, London (GB); Karthik Raj GURUCHANDRAN, Hampshire (GB)

(21) Appl. No.: 19/107,155

(22) PCT Filed: Aug. 25, 2023
(86) PCT No.: PCT/EP2023/073385

§ 371 Date: Feb. 27, 2025

(30) Foreign Application Priority Data
Aug. 31, 2022 (GB) 2212657.7

(51) Int. Cl. A24F 40/465; A24F 40/50

(52) U.S. Cl. CPC A24F 40/465; A24F 40/50

(57) ABSTRACT

A method of operating an aerosol generator of an aerosol provision device including determining a resonant frequency f0 of one or more induction elements; supplying an alternating current to the one or more induction elements over multiple cycles of time, wherein each cycle of time comprises one or more first time periods T1 and one or more second time periods T2; supplying the alternating current to the one or more induction elements at a first frequency f1 during the one or more first time periods T1, wherein 0.9≤f1/f0≤1.1; and supplying the alternating current to the one or more induction elements at a second different frequency f2 during the one or more second time periods T2, wherein either: (a) f2/f0≤0.9; or (b) f2/f0≥1.1, and wherein f2>0.

### RELATED APPLICATIONS

The present application is a National Phase entry of PCT/EP2023/073385 filed Aug. 25, 2023, which claims priority to GB Application No. 2212657.7 filed Aug. 31, 2022, each of which is hereby incorporated by reference in their entirety.

### TECHNICAL FIELD

The present invention relates to a method of operating an aerosol generator of an aerosol provision device, an electronic circuit for an aerosol generator of an aerosol provision device, an aerosol provision device, an aerosol generating system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

It is known to provide an aerosol provision device comprising an aerosol generator comprising two induction coils.

It is desired to provide an improved method of operating an aerosol generator.

### SUMMARY

According to an aspect there is provided a method of operating an aerosol generator of an aerosol provision device comprising:
determining a resonant frequency f0 of one or more induction elements;
supplying an alternating current to the one or more induction elements over multiple cycles of time, wherein each cycle of time comprises one or more first time periods T1 and one or more second time periods T2;
supplying the alternating current to the one or more induction elements at a first frequency f1 during the one or more first time periods T1, wherein 0.9≤f1/f0≤1.1; and
supplying the alternating current to the one or more induction elements at a second different frequency f2 during the one or more second time periods T2, wherein either: (a) f2/f0≤0.9; or (b) f2/f0≥1.1, and wherein f2>0.

According to various embodiments an aerosol generator of an aerosol provision device is provided which is arranged to provide an alternating current to one or more induction elements. For example, the induction element may comprise a coil or an induction coil. The resonant frequency f0 of the induction element may be determined. The aerosol generator may be energized for an extended period of time which may be several minutes. The extended period of time may correspond with a session of use. The extended period of time or the overall session of use can be sub-divided into a plurality of cycles of time wherein each cycle of time may last e.g. 1 s.

A cycle of time may be further sub-divided in a plurality of first time periods T1 interspersed with a plurality of second time periods T2. For example, a cycle of time lasting 1 s may be sub-divided into a plurality of 10 ms first time periods T1, wherein subsequent first time periods T1 are interspersed with second time periods T2 which may also be 10 ms long. It will, of course, be understood that the first time periods T1 may be longer or shorter than 10 ms. Likewise, the second time periods T2 may also be longer or shorter than 10 ms.

Accordingly, for illustrative purposes only, a session of use which lasts e.g. 180 s might be considered as comprising 180 cycles of time, each cycle of time lasting 1 s. Each 1 s cycle of time may be sub-divided into e.g. 50 first time periods T1 and 50 second time periods T2. The first and second time periods T1,T2 may each last 10 ms.

According to various embodiments the aerosol generator may be arranged to supply an alternating current to the induction elements during each first time period T1 during which time the induction element may be considered as being energized or otherwise in an ON state. In a subsequent second time period T2, the induction element may be considered as being not energized or otherwise in an OFF state.

During the first time periods T1, the aerosol generator may be arranged to supply the alternating current to the induction elements at a frequency f1 which is close to the determined resonant frequency f0 of the induction element. In particular, the alternating current may be supplied at a frequency f1 which is within ±10% of the determined resonant frequency f0 of the induction elements. As a result of being driven at a frequency f1 close to the resonant frequency f0 of the induction elements an efficient process is established. As a result, an induced current is duly created in a susceptor located adjacent a coil or induction coil forming part of the induction element and the susceptor will therefore be heated during each first time period T1.

In contrast, during the second time periods T2, the aerosol generator is arranged to supply the alternating current to the induction elements at a frequency f2 which is either substantially lower or substantially greater than the determined resonant frequency f0 of the induction element. In particular, the alternating current is supplied at a frequency f2 which is either at least 10% lower or at least 10% higher than the determined resonant frequency f0 of the induction elements. As a result of being driven at a frequency f2 which is not close to the resonant frequency f of the induction elements, the drive frequency is inefficient and essentially the induction elements can be considered as being in an OFF state. As a result, substantially no induced current is created in a susceptor located adjacent a coil or induction coil forming part of the induction element and hence the susceptor is not heated by the alternating current applied to the induction elements during the second time periods T2.

It will be understood that the alternating current during the one or more second time periods T2 is not switched OFF i.e. the frequency f2 is not reduced to zero. However, the frequency f2 is sufficiently far removed from the resonant frequency f0 of the induction element that essentially no current is induced in a susceptor located adjacent the induction element and hence the susceptor is not heated during the second time periods T2.

A benefit of the approach according to various embodiments of essentially applying an alternating current to an induction element where the frequency of the applied alternating current repeatedly switches between a first frequency f1 which is close to the resonant frequency f0 and a second frequency f2 which is distant from the resonant frequency f0 is that the approach is simpler to implement compared with turning the alternating current OFF during the second time periods T2. Furthermore, the tolerances of the electronic components in the electronic circuit can be relaxed and the process is less demanding to individual components in the electronic circuit. As a result, the lifetime of the electronic circuit can be extended due a reduced failure of individual electronic components and the reliability of the electronic circuit is also improved.

According to various embodiments the electronic circuit according to various embodiments and the approach of not repeatedly switching the alternating current ON and OFF but rather repeatedly switching the frequency of the alternating current between a first frequency f1 which is close to resonant frequency f0 and a second frequency f2 which is distant from the resonant frequency f0 imposes less demand upon the DC battery. It will be understood by those skilled in the art that according to various embodiments a DC battery is arranged to supply a DC voltage to a plurality of H-bridge driver circuits which are each in turn connected to a current switching circuit comprising two dual MOSFETs. The driver circuits cause the direction of the current supplied to the terminals of an induction element such as a coil or an induction coil to constantly change direction at a relatively high frequency. As a result, an alternating current is essentially generated from the DC battery by the H-bridge driver circuits in combination with the MOSFETs which are driven by the H-bridge driver circuits. For purely illustrative purposes, the alternating current which is generated may have a frequency of approx. 2 MHz.

It will be understood that the approach according to various embodiments places less demand upon the DC battery and hence extends the lifetime of the DC battery. In particular, the approach according to various embodiments involves rapidly switching the frequency of the applied alternating current between a frequency f1 which is close to the resonant frequency f0 of the induction element and a frequency f2 which is detuned from the resonant frequency f0 rather than be switched OFF.

It will be understood therefore that according to various embodiments the DC battery is not repeatedly switched ON and OFF at a high frequency which would occur if the H-bridge driver circuits were repeatedly supplied with a pulsed DC signal.

According to various embodiments an aerosol generator is provided wherein the frequency at which an induction coil is driven by an alternating current is repeatedly switched between a first frequency f1 which is close to the resonant frequency f0 and a second frequency f2 which is detuned from the resonant frequency f0. Such an approach of instead of switching the alternating current ON/OFF but rather repeatedly switching the frequency of the applied current between a frequency f1 which is close to the resonant frequency f0 and a frequency f2 which is de-tuned from the resonant frequency f0 enables a more resilient, simpler and more power efficient electronic circuit to be provided and in particular places less demand upon the DC battery.

A benefit of the disclosed approach is that despite the fact that the alternating circuit is not switched OFF during the second time periods T2, overall the electronic circuit can be designed so as to utilize less power since it is not necessary for the electronic circuit to include components which require fast switching ON and OFF of the alternating current. Instead, according to various embodiments the alternating current is repeatedly switched every few milliseconds between a frequency f1 which is close to the resonant frequency f0 and a frequency f2 which is distant from the resonant frequency f0 but which is not zero.

Optionally, f0 is in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

Optionally, f1 is in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

Optionally, f2 is in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

Optionally, the one or more induction elements comprise one or more induction coils.

According to another aspect there is provided an electronic circuit for an aerosol generator of an aerosol provision device comprising:
a circuit element arranged to determine a resonant frequency f0 of one or more induction elements; and
a driver arrangement for supplying an alternating current to the one or more induction elements over multiple cycles of time, wherein each cycle of time comprises one or more first time periods T1 and one or more second time periods T2, wherein the driver arrangement is arranged: (i) to supply, in use, the alternating current to the one or more induction elements at a first frequency f1 during the one or more first time periods T1, wherein 0.9≤f1/f0≤1.1; and (ii) to supply, in use, the alternating current to the one or more induction elements at a second different frequency f2 during the one or more second time periods T2, wherein either: (a) f2/f0≤0.9; or (b) f2/f0≥1.1, and wherein f2>0.

Optionally, f0 is in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

Optionally, f1 is in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

Optionally, f2 is in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

Optionally, the one or more induction elements comprise one or more induction coils.

According to another aspect there is provided an aerosol provision device comprising: an electronic circuit as described above.

Optionally, the aerosol provision device further comprises an aerosol generator.

Optionally, the aerosol generator comprises one or more induction elements.

Optionally, the one or more induction elements comprise one or more induction coils.

According to another aspect there is provided an aerosol generating system comprising: an aerosol provision device as described above; and an aerosol generating article comprising aerosol generating material.

According to another aspect there is provided a method of generating an aerosol comprising:
providing an aerosol provision device as described above;
inserting an aerosol generating article comprising aerosol generating material into the aerosol provision device; and
energizing the aerosol provision device in order to generate aerosol from the aerosol generating material.

### BRIEF DESCRIPTION OF THE DRAWINGS

Various embodiments will now be described, by way of example only, and with reference to the accompanying drawings in which:

FIG. 1 illustrates an electronic circuit of an aerosol provision device comprising two induction coils and shows an aerosol generating article located within a heating chamber of the aerosol provision device;

FIG. 2 shows in greater detail a portion of an electronic circuit of an aerosol provision device according to various embodiments wherein two induction coils are each driven by an H-bridge arrangement comprising two driver circuits, each driver circuit being arranged to drive two MOSFETs;

FIG. 3 illustrates a method of operating an aerosol generator or an aerosol provision device according to various embodiments; and

FIG. 4 illustrates schematically an electronic circuit for an aerosol generator of an aerosol provision device according to various embodiments.

### DETAILED DESCRIPTION

Induction heating is a process of heating an electrically conducting object (or susceptor) by electromagnetic induction. An induction heater may comprise an induction element, such as one or more coils or an electromagnet (coils may be part of an electromagnet), and circuitry for passing a varying electric current, such as an alternating electric current, through the one or more coils. The varying electric current in the coils produces a varying magnetic field. The varying magnetic field penetrates a susceptor suitably positioned with respect to the one or more coils, generating eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor i.e. by the varying orientation of magnetic dipoles in the magnetic material as a result of their alignment with the varying magnetic field. In induction heating, as compared to heating by conduction, heat is generated inside the susceptor, allowing for rapid heating. Further, there need not be any physical contact between the induction heater and the susceptor, allowing for enhanced freedom in construction and application.

An induction heater may be considered as comprising a RLC circuit, comprising a resistance (R) provided by a resistor, an inductance (L) provided by an induction element (e.g. one or more coils or an electromagnet which may be arranged to inductively heat a susceptor) and a capacitance (C) provided by a capacitor, connected in series. In some cases, resistance is provided by the ohmic resistance of parts of the circuit connecting the inductor and the capacitor, and hence the RLC circuit need not necessarily include a resistor as such. Such a circuit may be referred to, for example, as an LC circuit. Such circuits may exhibit electrical resonance, which occurs at a particular resonant frequency when the imaginary parts of impedances or admittances of circuit elements are equal and opposite and hence cancel each other out.

Resonance occurs in an RLC or LC circuit when a collapsing magnetic field of an inductor generates an electric current in its windings that charges a capacitor. The capacitor then discharges providing an electric current that builds a magnetic field in the inductor. Energy is stored in an electric field whilst the capacitor is charged and in a magnetic field as current flows through the inductor. Energy can be transferred from one to the other within the circuit and this can be oscillatory in nature. When the circuit is driven at the resonant frequency, the series impedance of the inductor and the capacitor is at a minimum, and the circuit current is at a maximum. Driving the RLC or LC circuit at or near the resonant frequency may therefore provide for effective and/or efficient induction heating.

As will be understood by those skilled in the art, a transistor is a semiconductor device for switching electronic signals. A transistor typically comprises at least three terminals for connection to an electronic circuit. A field effect transistor (FET) is a specific type of transistor in which the effect of an applied electric field may be used to vary the effective conductance of the transistor.

A field effect transistor may comprise a body B, a source terminal S, a drain terminal D, and a gate terminal G. A field effect transistor comprises an active channel comprising a semiconductor through which charge carriers (e.g. electrons or holes) may flow between the source S and the drain D. The conductivity of the channel i.e. the conductivity between the drain D and the source S terminals, is a function of the potential difference between the gate G and source S terminals, for example generated by a potential applied to the gate terminal G.

One type of field effect transistors are enhancement mode FETs. It will be understood that with enhancement mode FETs, the FET will be in an OFF state (i.e. substantially preventing current from passing therethrough) when there is a substantially zero gate G to source S voltage, and the enhancement mode FET may be turned ON (i.e. substantially allowing current to pass therethrough) when there is a substantially non-zero gate G to source S voltage.

An n-channel (or n-type) field effect transistor (n-FET) is a field effect transistor whose channel comprises a n-type semiconductor, where electrons are the majority carriers and holes are the minority carriers. For example, n-type semiconductors may comprise an intrinsic semiconductor (such as silicon for example) doped with donor impurities (such as phosphorus for example). In n-channel FETs, the drain terminal D is placed at a higher potential than the source terminal S (i.e. there is a positive drain-source voltage, or in other words a negative source-drain voltage). In order to turn an n-channel FET ON (i.e. to allow current to pass therethrough), a switching potential is applied to the gate terminal G that is higher than the potential at the source terminal S.

A p-channel (or p-type) field effect transistor (p-FET) is a field effect transistor whose channel comprises a p-type semiconductor, where holes are the majority carriers and electrons are the minority carriers. For example, p-type semiconductors may comprise an intrinsic semiconductor (such as silicon for example) doped with acceptor impurities (such as boron for example). In p-channel FETs, the source terminal S is placed at a higher potential than the drain terminal D (i.e. there is a negative drain-source voltage, or in other words a positive source-drain voltage). In order to turn a p-channel FET ON (i.e. to allow current to pass therethrough), a switching potential is applied to the gate terminal G that is lower than the potential at the source terminal S (and which may, for example, be higher than the potential at the drain terminal D).

A metal-oxide-semiconductor field effect transistor (MOSFET) is a field effect transistor whose gate terminal G is electrically insulated from the semiconductor channel by an insulating layer. In some examples, the gate terminal G may be metal, and the insulating layer may be an oxide (such as silicon dioxide for example), hence “metal-oxide-semiconductor”. However, in other examples, the gate may be made from materials other than metal, such as polysilicon, and/or the insulating layer may be made from materials other than an oxide, such as other dielectric materials. Such devices are nonetheless typically referred to as metal-oxide-semiconductor field effect transistors (MOSFETs), and it is to be understood that as used herein the term metal-oxide-semiconductor field effect transistor or MOSFET is to be interpreted as including such devices.

One type of MOSFET is an n-channel (or n-type) MOSFET where the semiconductor is n-type. An n-channel MOSFET (n-MOSFET) may be operated in the same way as described above in relation to an n-channel FET. Another type of MOSFET is a p-channel (or p-type) MOSFET, where the semiconductor is p-type. A p-channel MOSFET (p-MOSFET) may be operated in the same way as described above in relation to a p-channel FET.

An n-MOSFET typically has a lower source-drain resistance than that of a p-MOSFET. It will be understood that when an n-MOSFET is in an ON state (i.e. where current is passing therethrough), then an n-MOSFET will generate less heat compared with a p-MOSFET. Accordingly, an n-MOSFET may waste less energy in operation compared to a p-MOSFET. Furthermore, n-MOSFETs typically have a shorter switching time (i.e. a characteristic response time from changing the switching potential provided to the gate terminal G to the MOSFET changing whether or not current passes therethrough) as compared to p-MOSFETs. This can allow for higher switching rates and improved switching control.

As will be described in more detail below, an H-bridge is an electronic circuit that switches the polarity of a voltage applied to a load. In the context of aerosol provision devices, an H-bridge circuit may be used to rapidly switch the direction of current flow through an inductor coil. It will be understood that by using an arrangement of MOSFETs as fast switches, the direction of current through an induction coil may be rapidly switched between a first direction and a second opposite direction. As a result, by applying a DC voltage to an H-bridge circuit comprising a number of MOSFETs an electronic circuit may be provided which allows an alternating current to pass through an induction coil. According to various embodiments, the frequency of the alternating current may be approx. 2 MHz.

As will be discussed in more detail below, the MOSFETs which are utilized in an H-bridge to supply an alternating current to an induction coil may according to various embodiments comprise enhancement type n-channel MOSFETs.

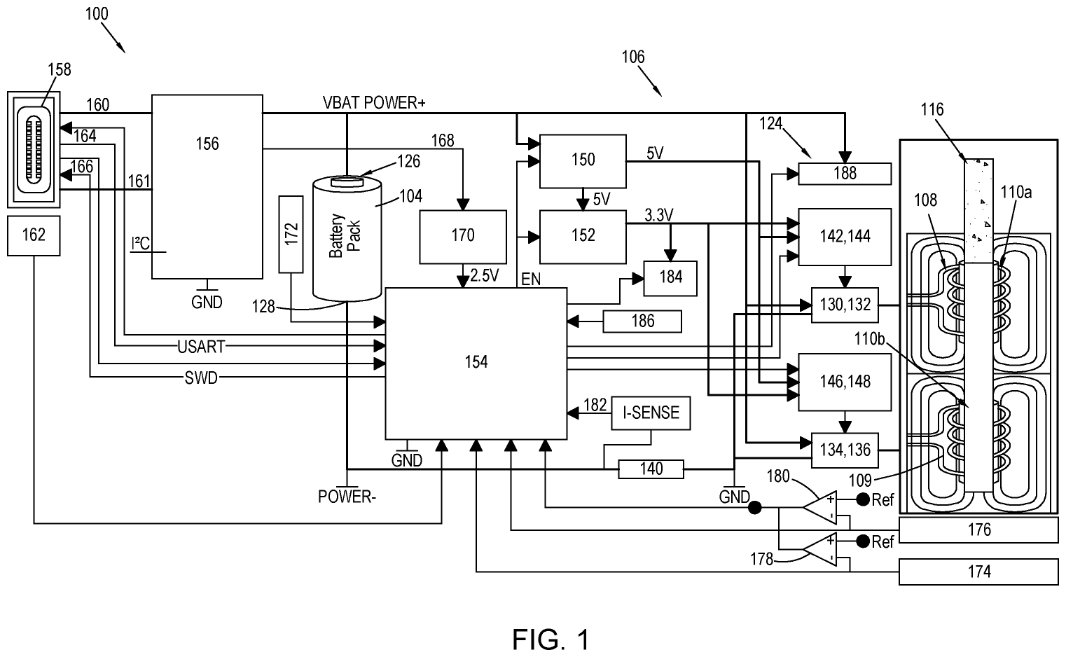

FIG. 1 illustrates schematically an electronic circuit 106 of an aerosol provision device 100. The aerosol provision device 100 comprises an aerosol generator comprising two induction heating elements 108, 109 and control electronics for energizing the heating elements 108, 109. The aerosol provision device 100 may comprise a single induction heating element or as shown in FIG. 1, the aerosol provision device 100 may comprise a first induction heating element 108 and a second induction heating element 109. The first induction heating element 108 may be arranged to heat, in use, a first susceptor 110a and the second induction heating element may be arranged to heat, in use, a second susceptor 110b.

An aerosol generating article 116 is shown inserted into the aerosol provision device 100 and it will be understood that the aerosol generating article 116 comprises aerosol generating material which is heated, in use, by the first and second susceptors 110a, 110b. It will be understood that the first and second susceptors 110a, 110b are heated due to an electric current being induced within the susceptors 110a, 110b. The first and second susceptors 110a, 110b may comprise a ferromagnetic portion, which may comprise a metal such as iron, nickel or cobalt. When an alternating current is driven through either the first and/or second induction elements 108, 109 the alternating current will cause the corresponding first and/or second susceptor 110a, 110b to heat up by Joule heating and/or by magnetic hysteresis heating, as described above. Accordingly, it will be understood that the electronic circuit 106 is arranged to pass an alternating electric current to the first and second induction elements 108, 109 which in turn induces a corresponding electric current in the first and second susceptors 110a, 110b which causes the susceptors 110a, 110b to become hot and hence to heat aerosol generating material (which is provided as a part of the aerosol generating article 116).

A DC power source 104 is provided which forms part of the electronic circuit 106. The DC power source 104 may comprise a battery or battery pack. The DC power source 104 is arranged to provide DC electrical power to the electronic circuit 106. The electronic circuit 106 is electrically connected to the first and second induction elements 108, 109. Each of the induction elements 108, 109 may comprise, for example, an electromagnet including one or more coils or solenoids. The first and second induction elements 108, 109 may be formed from copper wire. The electronic circuit 106 is arranged to convert a DC current provided by the DC power source 104 into an alternating current which is provided to the first and second induction elements 108,109. The electronic circuit 106 is arranged to drive the alternating current through the first and second induction elements 108, 109 at a relatively high frequency e.g. approx. 2 MHz.

The first and second susceptors 110a, 110b are arranged relative to the first and second induction heating elements 108, 109 for inductive energy transfer from the first and second induction heating elements 108, 109 to the first and second susceptors 110a, 110b. When an alternating current is driven through either the first and/or second induction elements 108, 109 the alternating current will cause the corresponding first and/or second susceptors 110a, 110b to heat up by Joule heating and/or by magnetic hysteresis heating. The first and/or second susceptors 110a, 110b are arranged to heat aerosol generating material which is provided as part of the aerosol generating article 116 e.g. by conduction, convection and/or radiation heating, in order to generate an aerosol in use.

According to various embodiments the first and/or second susceptors 110a, 110b may form part of the aerosol provision device 100. Embodiments are also contemplated wherein the first and/or second susceptors 110a, 110b and the aerosol generating material may be arranged to form an integral unit or consumable which may be inserted and/or removed from the aerosol provision device 100 and wherein the integral unit or consumable may be disposable. In some examples, the first and second induction elements 108, 109 may be removable from the aerosol provision device 100, for example for replacement. The aerosol provision device 100 may be hand-held. The aerosol provision device 100 may be arranged to heat the aerosol generating material in order to generate aerosol for inhalation by a user.

It is noted that, as used herein, the term “aerosol generating material” includes materials that provide volatilized components upon heating, typically in the form of vapor or an aerosol. Aerosol generating material may be a non-tobacco-containing material or a tobacco-containing material. For example, the aerosol generating material may be or comprise tobacco. Aerosol generating material may, for example, include one or more of tobacco per se, tobacco derivatives, expanded tobacco, reconstituted tobacco, tobacco extract, homogenised tobacco or tobacco substitutes. The aerosol generating material can be in the form of ground tobacco, cut rag tobacco, extruded tobacco, reconstituted tobacco, reconstituted material, liquid, gel, gelled sheet, powder, or agglomerates, or the like. Aerosol generating material also may include other, non-tobacco products which depending on the product, may or may not contain nicotine. Aerosol generating material may comprise one or more humectants, such as glycerol or propylene glycol.

The aerosol provision device 100 may comprise an outer body (not shown) which may be arranged to house the DC battery 104, the electronic circuit 106, the first and second induction elements 108, 109 and optionally also the first and second susceptors 110a, 110b. The outer body may comprise a mouthpiece to allow aerosol generated in use to exit the aerosol provision device 100.

In use, a user may activate the electronic circuit 106 by, for example, activating a button or via a puff detection component (not shown) in order to cause an alternating current to be driven through the first and second induction elements 108, 109, thereby inductively heating the first and second susceptors 110a, 110b which in turn will result in heating of the aerosol generating material so as to cause an aerosol to be generated. The aerosol may be generated and mixed with air which may be drawn into the aerosol provision device 100 via an air inlet (not shown). The mixture of aerosol and air may then be directed towards the mouthpiece where the aerosol then exits the aerosol provision device 100 and may be inhaled by a user.

The aerosol provision device 100 comprising the electronic circuit 106 and first and second induction elements 108, 109 in combination with the first and second susceptors 110a, 110b may be arranged to heat the aerosol generating material to a range of temperatures in order to volatilize at least one component of the aerosol generating material without combusting the aerosol generating material. For example, according to various embodiments the aerosol generating material may be heated to a temperature in the range 50-100° C., 100-150° C., 150-200° C., 200-250° C., 250-300°° C. or >300° C.

According to various embodiments the DC power source 104, which may comprise a battery pack, may be connected to a driver arrangement 124 for supplying electrical energy to the first and second induction elements 108,109 which may comprise two coils. The driver arrangement 124 may be connected to a positive terminal 126 of the battery pack 104 that provides a relatively high electric potential and to a negative terminal 128 of the battery pack 104 or to ground GND which provides a relatively low, zero or negative electric potential. A voltage is therefore established across the driver arrangement 124.

The driver arrangement 124 comprises a first full H-bridge driver circuit 142, 144 which is coupled to two dual MOSFETs 130, 132 for supplying an alternating current to a first induction element 108. The two dual MOSFETs 130, 132 may each comprise an enhancement type n-channel MOSFET.

The driver arrangement 124 further comprises a second full H-bridge driver circuit 146, 148 which is coupled to two further dual MOSFETs 134, 136 for supplying an alternating current to a second induction element 109. The two further dual MOSFETs 134, 136 may each comprise enhancement type n-channel MOSFETs. Accordingly, the overall driver arrangement may comprise eight MOSFETS 130, 132, 134, 136 which may comprise enhancement type n-channel MOSFETs.

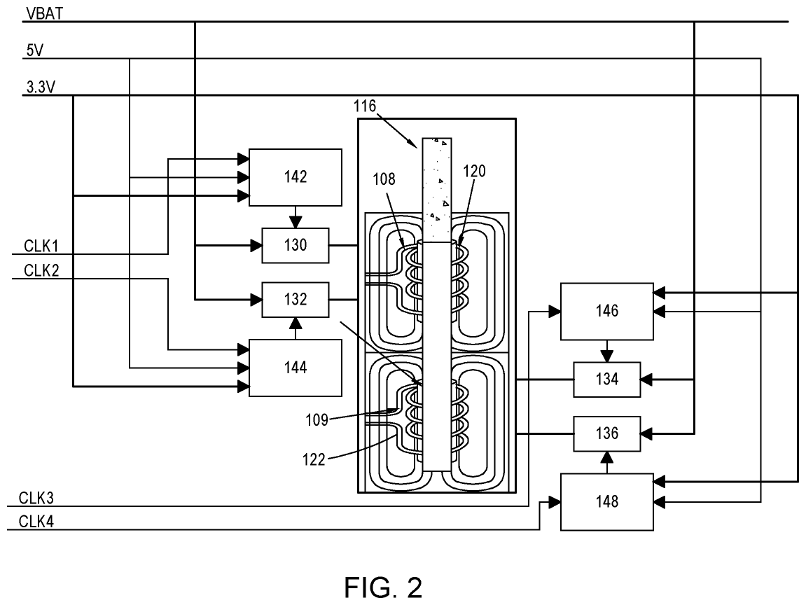

With reference to FIG. 2, the electronic circuit 106 may comprise a first full H-bridge which comprises a pair of MOSFETs 130 (driven by a first H-bridge driver circuit 142) connected to a first terminal of a first induction element 108 and a pair of MOSFETs 132 (driven by a second H-bridge driver circuit 144) connected to a second terminal of the first induction element 108. The first induction element 108 may comprise a first induction coil 120.

A second full H-bridge is provided which comprises two MOSFETs 134 (driven by a third H-bridge driver circuit 146) connected to a first terminal of a second induction element 109 and two MOSFETs 136 (driven by a fourth H-bridge driver circuit 148) connected to a second terminal of the second induction element 109. The second induction element 109 may comprise a second induction coil 122.

Each pair of MOSFETS 130, 132, 134, 136 may be connected to the high electric potential VBAT or VBAT POWER+ of the battery pack 104 and to the negative electric potential POWER− or GND (as shown in FIG. 1 but omitted from FIG. 2). With reference to FIG. 1, a resistor 140 (e.g. 2 mΩ) may be provided in the connection line between the battery pack 104 and the pairs of MOSFETs 130, 132, 134, 136.

Accordingly, the driver arrangement 124 as shown in FIG. 1 may comprise a first H-bridge driver circuit 142, a second H-bridge driver circuit 144, a third H-bridge driver circuit 146 and a fourth H-bridge driver circuit 148. The driver circuits 142, 144, 146, 148 are arranged to drive each of the switching elements or pairs of MOSFETs 130, 132, 134, 136 i.e. to control each pair of MOSFETs 130, 132, 134, 136 to be in either a conducting state or in a non-conducting state in order to change the direction of current between the terminals of the induction elements 108, 109.

As shown in more detail in FIG. 2, the four driver circuits 142, 144, 146, 148 may be provided with a bias or supply voltage of, for example, 5 V. The required value may vary depending on the specific driver. This supply voltage may be obtained from the high electric potential VBAT POWER+ (FIG. 1) or VBAT (FIG. 2) from the battery pack 104 or via a buck boost regulator or DC-to-DC converter 150 or another suitable regulator.

The aerosol provision device 100 may be operated in a first, normal or standard mode of operation and also in a second or boost mode operation. When the aerosol provision device 100 is operated in a second or boost mode of operation it may be desired to increase the temperature of one or both susceptors 110a, 110b e.g. to increase the temperature profile. In the second mode or boost mode of operation a 5V DC may be supplied to the driver circuits 142, 144, 146, 148.

In the first mode of operation the drivers 142, 144, 146, 148 may be provided with a lower voltage of e.g. 3.3 V. This supply voltage can be obtained from the 5 V of the buck boost regulator or DC-to-DC converter 150 via a voltage regulator 152. The voltage regulator 152 may comprise a low drop-out (LDO) regulator.

Thus, the driver arrangement 124 is arranged to provide, from an input direct current from the battery pack 104, an alternating current to the coils 120, 122 or their respective LC circuit for driving the first and second induction elements 108, 109 or coils 120, 122 in use.

With reference to FIG. 1, a central controlling unit 154 such as a microcontroller unit (“MCU”) may be provided. The central controlling unit 154 serves as a controller for the driver circuits 142, 144, 146, 148 i.e. the central controlling unit 154 may be arranged to control the circuits 142, 144, 146, 148 by, for example, providing a pulse-width modulation (“PWM”) signal to the driver circuits 142, 144, 146, 148, wherein the driver circuits 142, 144, 146, 148 in turn control the dual MOSFETs 130, 132, 134, 136.

The central controlling unit 154 may be arranged to set a frequency at which the dual MOSFETs 130, 132, 134, 136 are switched between a conducting state or a non-conducting state. As a result, the central controlling unit 154 is effectively arranged to set the frequency of an alternating current which is applied to the induction elements 108, 109.

According to various embodiments, the central controlling unit 154 may be arranged to determine the resonant frequency f0 of an induction element 108, 109. Furthermore, the central controlling unit 154 may be arranged to supply an alternating current to the induction elements 108, 109 at, for example, a first frequency f1 which is within 10% of the resonant frequency f0. The central controlling unit 154 may also be arranged to supply an alternating current to the induction elements 108, 109 at, for example, a second frequency f2 which is either at least 10% below the resonant frequency f0 or at least 10% above the resonant frequency f0.

The central controlling unit 154 may also control various other functions and components of the electronic circuit 106. For example, the central controlling unit 154 may control the buck boost regulator or DC-to-DC converter 150 and the voltage regulator 152 so that a voltage of either 5V (boost mode) or 3.3 V (normal mode) is supplied to the driver circuits 142, 144, 146, 148.

As shown in FIG. 1, the electronic circuit 106 may also comprise a battery charging circuit 156 which may be connected to the battery pack 104 at the positive terminal 126 and also to ground GND. The battery charging circuit 156 may be connected to an interface 158 such as an USB interface, for example, via a positive connection line 160 for high electric potential and a corresponding negative connection line 161. This allows connection of a plug of a power supply, for example, to the aerosol provision device 100 in order to charge or re-charge the battery pack 104.

A USB temperature sensor 162 such as a Negative Temperature Coefficient (“NTC”) temperature sensor may be located at the interface 158 and may be connected to the central controlling unit 154. The USB temperature sensor 162 allows the temperature of the interface 158 to be monitored and for charging of the battery 104 to be controlled. For example, charging may be interrupted if the temperature of the interface 158 is determined to be a temperature above a maximum desired temperature threshold.

A data connection line 164 such as a Universal Synchronous/Asynchronous Receiver Transmitter (“USART”) or other type of connection may be provided between the interface 158 and the central controlling unit 154. This allows data exchange between the central controlling unit 154 and an external device connected to the aerosol provision device 100 via the interface 158, for example, for controlling charging. Both data transfer directions are indicated via two lines with arrows in FIG. 1 with one from the central controlling unit 154 to the interface 158 and one from the interface 158 to the central controlling unit 154.

A debugging connection line 166 such as a Serial Wire Debug (“SWD”) or other type of connection line may be provided between the interface 158 and the central controlling unit 154. The debugging connection line 166 allows debugging of the central controlling unit 154 via an external device connected to the aerosol provision device 100 via the connector or interface 158. Both data transfer directions are indicated via two lines with arrows, one from the central controlling unit 154 to the interface 158 and one from the interface 158 to the central controlling unit 154.

The battery charging circuit 156 may be arranged to provide power to the central controlling unit 154 via power line 168. For example, the central controlling unit 154 might be supplied with a voltage of 2.5V. A voltage regulator 170 of any suitable type might be used to generate the required supply voltage for the central controlling unit 154.

According to various embodiments a battery temperature sensor 172 such as a NTC temperature sensor may be provided at the battery pack 104 and may be connected to the central controlling unit 154. The battery temperature sensor 172 allows the temperature of the battery pack 104 to be monitored and enables charging of the battery pack 104 to be controlled. For example, charging may be interrupted if the battery pack 104 is determined to be at too high a temperature. Furthermore, regular operation of the aerosol provision device 100 may be controlled based upon the determined temperature of the battery pack 104.

A temperature sensor 174 such as a NTC temperature sensor may be provided adjacent the first and second induction elements 108, 109 or the respective coils 120, 122 and may be connected to the central controlling unit 154. According to various embodiments a thermocouple temperature sensor 176 may also be provided. In particular, each coil 120, 122 may be monitored by a separate thermocouple 176 and one or both thermocouples 176 may be connected to the central controlling unit 154. A reference voltage Ref may be provided to a first comparator 178 coupled to the temperature sensor 174. Similarly, a reference voltage Ref may be provided to a second comparator 180 coupled to the thermocouples 180. The comparators 178, 180 may be provided in order to achieve measurable voltages thereby enabling monitoring of the temperatures of the coils 120, 122 or the respective induction element 108, 109 to be achieved and for their operation to be controlled. For example, the operating frequency of an alternating current applied to the induction elements 108, 109 may be changed, varied, increased or decreased depending upon the determined temperature of the induction elements 108, 109 or coils 120, 122. For example, as will be understood by those skilled in the art, the resonant frequency f0 of the coils 120, 122 or the induction elements 108, 109 may change with temperature. For example, as the temperature of the induction elements 108, 109 increases with time then the resonant frequency f0 of the induction elements 108, 109 or coils 120, 122 may decrease with time.

The central controlling unit 154 may be configured to measure the current supplied to the induction elements 108, 109 or coils 120, 122 by the dual MOSFETs (switches) 130, 132, 134, 136. For example, a current sensing component I_SENSE may be provided in a line which is connected between the MOSFETs 130, 132, 134, 136 and/or the H-bridge driver circuits 142, 144, 146, 148 and the negative terminal 128 at the resistor 140. An analogue-to-digital converter (“ADC”) 182 may be used to convert the determined current into a digital voltage level which is provided to the central controlling unit 154.

An indication light 184 (e.g. a LED) may be provided in order to indicate one of several operating states of the aerosol provision device 100. The LED 184 may comprise a RGB LED i.e. a LED capable of providing illumination across the entirety of the visible color spectrum or only parts thereof. For example, the LED 184 may be illuminated to display red, green, blue, white and a variety of different hues. The indication light 184 may be supplied with power via voltage regulator 152 and may be controlled by the central controlling unit 154. The indication light 184 may be provided as part of a user interface located on an outer portion of the aerosol provision device 100.

A button or key 186 may be provided e.g. on the outer housing of at the aerosol provision device 100. The button or key 186 may be used for changing an operating mode of the aerosol provision device 100 or to switch power ON or OFF or the like. The button or key 186 may be connected to the central controlling unit 154 which receives signals provided by the button or key 186 being operated and may implement the required operation change, for example.

A haptic motor 188 or any other haptic feedback element may be provided. The haptic motor 188 may be supplied with power from the battery back 104 and may be controlled by the central controlling unit 154. This allows a user of the aerosol provision device 100 to receive haptic feedback during use.

The central controlling unit 154 or the driver controller part thereof may be arranged to control the frequency of the alternating current which is provided to the coils 120, 122 or the LC circuit comprising the coils, via the driver arrangement 124 and hence the frequency of the alternating current driven through the induction element 108, 109 or coils 120, 122. The induction elements 108, 109 or respective coils 120, 122 may be operated in various mode of operation wherein only one or both induction elements 108, 109 are energized at any particular point in time.

As mentioned above, the LC circuits may exhibit resonance. The central controlling unit 154 or the driver controller part thereof may control the frequency of the alternating current driven through the coils or the LC circuit (i.e. the drive frequency) in order to be at or near the resonant frequency of the one or both of the coils 120,122 or the LC circuit. For example, the drive frequency may be in the MHz range, for example in the range 0.5 to 1.5 MHz e.g. 1 MHz. Other embodiments are contemplated wherein the drive frequency may be in the range 1-2 MHz. It will be appreciated that other frequencies may be used, for example, depending on the particular coils or LC circuit (and/or components thereof), and/or susceptors 110a, 110b utilized. For example, it will be appreciated that the resonant frequency f0 of the LC circuit may be dependent upon the inductance L of the coils 120, 122 and the capacitance C of the circuit, which in turn may be dependent upon the inductor elements 108, 109, capacitor and susceptors 110a, 100b used.

In use, when the central controlling unit 154 or the driver controller part thereof is activated, for example by a user, the central controlling unit 154 or the driver controller part thereof may control the driver arrangement 124 to drive an alternating current through one or more of the coils 120, 122 or the LC circuit and hence through the induction elements 108,109 thereby causing induction heating of the susceptors 110a, 110b. As the susceptors 110a, 110b become hot, they may heat aerosol generating material which forms part of the aerosol generating article 116 and as a result aerosol may be generated for inhalation by a user.

Referring to FIG. 2, there is illustrated schematically in more detail part of the electronic circuit 106 of the aerosol provision device 100 of FIG. 1. As described above with reference to FIG. 1, the driver arrangement may comprise an H-bridge configuration comprising two full H-bridges, one per coil 120, 122. Each full H-bridge comprises four switching elements which may comprise transistors or pairs of MOSFETs 130, 132, 134, 136. The four pairs of MOSFETs 130, 132, 134, 136 may be provided as two dual MOSFETs per full H-bridge. The dual MOSFETs 130, 132, 134, 136 are shown in FIG. 2 and two pairs of MOSFETs 130, 132, 134, 136 are provided per coil 120, 122. Each pair of MOSFETs 130, 132, 134, 136 is connected to the high electric potential VBAT POWER+ or VBAT of the battery pack and to the negative electric potential POWER− or GND (not shown here).

Accordingly, two half H-bridge drivers 142, 144; 146, 148 are provided per full H-bridge or per pair of dual MOSFETs 130, 132, 134, 136. The H-bridge drivers 142, 144; 146, 148 may be provided with a bias or supply voltage of, for example, 5 V (e.g. in a boost mode of operation) and with a control or supply voltage of, for example, 3.3 V (e.g. during a standard mode of operation) as described above.

As also described above with reference to FIG. 1, a central controlling unit such as a MCU 154 serves as a controller for the drivers 142, 144, 146, 148 i.e. the MCU 154 may be arranged to control the drivers 142, 144, 146, 148 and to provide the drivers 142, 144, 146, 148 with a clock signal. For example, a first clock signal CLK1 may be provided to the first driver 142 and a second clock signal CLK2 may be provided to the second driver 144 wherein the drivers 142, 144 are arranged to drive pairs of MOSFETs 130, 132 connected to the first coil 120. A third clock signal CLK3 may be provided to the third driver 146 and a fourth clock signal CLK4 may be provided to the fourth driver 148 wherein the drivers 146, 148 are arranged to drive pairs of MOSFETs 134, 136 connected to the second coil 122.

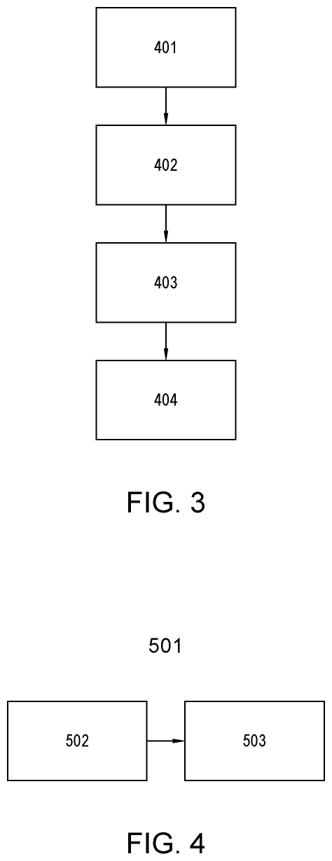

A method of operating an aerosol generator of an aerosol provision device 100 according to various embodiments will now be described in more detail with reference to FIG. 3. According to various embodiments the aerosol provision device 100 comprises a control system which is arranged in a first step 401 to determine a resonant frequency f0 of one or more induction elements 108, 109 which form part of the aerosol provision 100.

The control system is arranged to supply in a second step 402 an alternating current to the one or more induction elements 108, 109 over multiple cycles of time. Each cycle of time may, for example, comprise a time period of e.g. 1 s. Each time cycle of time may be considered as further comprising a plurality of first time periods T1 which are interspersed with a plurality of second time periods T2. The control system is arranged to supply in a third step 403 an alternating current to the one or more induction elements 108, 109 at a first frequency f1 during each of the first time periods T1. The first frequency f1 is arranged to be a frequency which is within 10% of the resonant frequency f0 i.e. 0.9≤f1/f0≤1.1.

The control system may then supply in a fourth step 404 the alternating current to the one or more induction elements 108, 109 at a second different frequency f2 during each of the second time periods T2. The second frequency f2 is different to the first frequency f1 and in particular is substantially different from the resonant frequency f0. For example, the second frequency f2 may be less than 90% of the resonant frequency f0 or alternatively, the second frequency may be greater than 110% of the resonant frequency f. In other words, according to various embodiments either f2/f0≤0.9 or f2/f0≥1.1. It will be understood that the second frequency is greater than zero i.e. f2>0.

According to various embodiments f0 may be in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz. For example, embodiments are contemplated wherein f1 may be in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz. Optionally, f2 may be in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz. The one or more induction elements 108, 109 may comprise one or more induction coils 120, 122.

With reference to FIGS. 1 and 2, according to various embodiments an aerosol generator for an aerosol provision device 100 is provided which may be arranged to provide an alternating current to one or more induction elements 108, 109 such as a coil or an induction coil 110a, 110b. The resonant frequency f0 of the induction element 108, 109 may be determined by the electronic circuit 106.

The aerosol generator may be energized for an extended period of time which may be several minutes. For example, an aerosol generating article 116 may be inserted into the aerosol provision device 100 and a session of use lasting 3-4 minutes may be commenced. The session of use may therefore last for several minutes and this time may be sub-divided into multiple cycles of time wherein a single cycle may last 1 s.

It will be understood that the duration of a single cycle of time may be set to a convenient period of time dependent upon a clock signal provided to the electronic circuit 106. A cycle of time may be further sub-divided in a plurality of first time periods T1 interspersed with a plurality of second time periods T2. For example, a cycle of time lasting 1 s may be sub-divided into a plurality of 10 ms first time periods T1, wherein subsequent first time periods T1 are interspersed with second time periods T2 which may also be 10 ms long. It will, of course, be understood that the first time periods T1 may be longer or shorter than 10 ms. Likewise, the second time periods T2 may also be longer or shorter than 10 ms.

According to various embodiments the aerosol generator may be arranged to supply an alternating current to the induction elements 108, 109 during a first time period T1 during which time the induction element 108, 109 may be considered as being energized or otherwise in an ON state. In a subsequent second time period T2, the induction element 108, 109 may be considered as being not energized or otherwise in an OFF state.

During the first time periods T1, the aerosol generator is arranged to supply the alternating current to the induction elements 108, 109 at a frequency f1 which is close to the determined resonant frequency f0 of the induction element 108, 109. In particular, the alternating current is supplied at a frequency f1 which is within +10% of the determined resonant frequency f0 of the induction elements 108, 109. As a result of being driven at a frequency f1 which is close to the resonant frequency f0 of the induction elements 108, 109 an efficient process is established. As a result, an induced current is duly created in a susceptor 110a, 110b located adjacent a coil or induction coil 120, 122 forming part of the induction element 108, 109 and the susceptor 110a, 110b will as a result become hot.

In contrast, during the second time periods T2, the aerosol generator is arranged to supply the alternating current to the induction elements 108, 109 at a frequency f2 which is substantially lower or greater than the determined resonant frequency f0 of the induction elements 108, 109. In particular, the alternating current is supplied at a frequency f2 which is either at least 10% lower or at least 10% higher than the determined resonant frequency f0 of the induction elements 108, 109. As a result of being driven at a frequency which is not close to the resonant frequency f0 of the induction elements 108, 109, the drive frequency is highly inefficient and essentially the induction elements 108, 109 can be considered as being in an OFF state. As a result, essentially no induced current is created in a susceptor 110a, 110b located adjacent a coil or induction coil 120, 122 forming part of the induction element 108, 109 and the susceptor 110a, 110b is not heated by the alternating current applied to the induction elements 108, 109.

It will be understood that the alternating current during the one or more second time periods T2 is not switched OFF i.e. the frequency f2 is not reduced to zero. However, the frequency f2 is sufficiently far removed from the resonant frequency f0 of the induction element 108, 109 that essentially no current is induced in a susceptor 110a, 110b located adjacent the induction element 108, 109.

A benefit of the approach according to various embodiments of essentially applying an alternating current to an induction element 108, 109 where the frequency of the applied alternating current repeatedly switches between a first frequency f1 which is close to the resonant frequency f0 and a second frequency f2 which is distant from the resonant frequency f0 is that the approach is simpler to implement compared with turning the alternating current OFF during the second time periods T2. Furthermore, the tolerances of the electronic components in the electronic circuit 106 can be relaxed and the process is less demanding to individual components in the electronic circuit 106. As a result, the lifetime of the electronic circuit 106 can be extended due a reduced failure of individual electronic components and the reliability of the electronic circuit 106 is also improved. A yet further benefit is that despite the fact that the alternating circuit is not switched OFF during the second time periods T2, overall the electronic circuit 106 can be designed so as to utilize less power because it is not necessary for the electronic circuit 106 to include components which require fast switching OFF of the alternating current. Instead, according to various embodiments the alternating current is repeatedly switched every few milliseconds between a frequency f1 which is close to the resonant frequency f0 and a frequency f2 which is distant from the resonant frequency f0.

It will be understood, therefore, that an aerosol generator is provided wherein the frequency at which an induction coil 108, 109 is driven by an alternating current is repeatedly switched between a first frequency f1 which is close to the resonant frequency f0 and a second frequency f2 which is de-tuned from the resonant frequency f0. Such an approach of instead of switching the alternating current OFF but rather switching the frequency to a frequency f2 which is de-tuned from the resonant frequency f0 enables a more resilient, simpler and more power efficient electronic circuit 106 to be provided.

According to various embodiments the electronic circuit 106 according to various embodiments and the approach of not repeatedly switching the alternating current ON and OFF but rather repeatedly switching the frequency of the alternating current between a first frequency f1 which is close to resonant frequency f0 and a second frequency f2 which is distant from resonant frequency f0 imposes less demand upon the DC battery 104. It will be understood by those skilled in the art that the DC battery 104 as shown in FIG. 1 supplies a DC voltage to H-bridge driver circuits 142, 144, 146, 148 each connected to a pair of MOSFETs 130, 132, 134, 136. The H-bridge driver circuits 142, 144, 146, 148 causes the direction of current supplied to terminals of an induction element 106, 108 such as a coil or an induction coil 120, 122 to constantly change direction so that an alternating current is generated from the DC battery 104.

It will be understood that approach according to various embodiments places less demand upon the DC battery 104 and hence extends the lifetime of the DC battery 104.

FIG. 4 illustrates two components of an electronic circuit 501 for an aerosol generator of an aerosol provision device 100. According to various embodiments a circuit element 502 is provided which is arranged to determine a resonant frequency f0 of one or more induction elements 108, 109. The electronic circuit also includes a driver arrangement 503.

According to various embodiments, the driver arrangement 503 may be arranged to supply an alternating current to the one or more induction elements 108, 109 over multiple cycles of time. Each cycle of time comprises one or more first time periods T1 and one or more second time periods T2. According to various embodiments the driver arrangement 503 is firstly arranged to supply, in use, the alternating current to the one or more induction elements 108, 109 at a first frequency f1 during the one or more first time periods T1, wherein 0.9≤f1/f0≤1.1.

The driver arrangement 503 may also be arranged to supply, in use, an alternating current to the one or more induction elements 108, 109 at a second different frequency f2 during the one or more second time periods T2, wherein either: (a) f2/f0≤0.9; or (b) f2/f0≥1.1, and wherein f2>0. According to various embodiments f0 may be in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz. Optionally, f1 may be in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz. Optionally, f2 may be in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

In order to address various issues and advance the art, this disclosure shows by way of illustration various embodiments. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. A method of operating an aerosol generator of an aerosol provision device comprising:
determining a resonant frequency f0 of one or more induction elements;
supplying an alternating current to the one or more induction elements over multiple cycles of time, wherein each cycle of time comprises one or more first time periods T1 and one or more second time periods T2;
supplying the alternating current to the one or more induction elements at a first frequency f1 during the one or more first time periods T1, wherein 0.9≤f1/f0≤1.1; and
supplying the alternating current to the one or more induction elements at a second different frequency f2 during the one or more second time periods T2, wherein either: (a) f2/f0≤0.9; or (b) f2/f0≥1.1, and wherein f2>0.

2. A method as claimed in claim 1, wherein f0 is in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

3. A method as claimed in claim 1, wherein f1 is in the range:
(i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

4. A method as claimed in claim 1, wherein f2 is in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

5. A method as claimed in claim 1, wherein the one or more induction elements comprise one or more induction coils.

6. An electronic circuit for an aerosol generator of an aerosol provision device comprising:
a circuit element arranged to determine a resonant frequency f0 of one or more induction elements; and
a driver arrangement for supplying an alternating current to the one or more induction elements over multiple cycles of time, wherein each cycle of time comprises one or more first time periods T1 and one or more second time periods T2, wherein the driver arrangement is arranged:
(i) to supply, in use, the alternating current to the one or more induction elements at a first frequency f1 during the one or more first time periods T1, wherein 0.9≤f1/f0≤1.1; and
(ii) to supply, in use, the alternating current to the one or more induction elements at a second different frequency f2 during the one or more second time periods T2, wherein either: (a) f2/f0≤0.9; or (b) f2/f0≥1.1, and wherein f2>0.

7. An electronic circuit as claimed in claim 6, wherein f0 is in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

8. An electronic circuit as claimed in claim 6, wherein f1 is in the range: (i) <0.5 MHz; (ii) 0.5-1.0 MHz; (iii) 1.0-1.5 MHz; (iv) 1.5-2.0 MHz; (v) 2.0-2.5 MHz;
(vi) 2.5-3.0 MHz; (vii) 3.0-3.5 MHz; (viii) 3.5-4.0 MHz; or (ix) >4.0 MHz.

9. An electronic circuit as claimed in claim 6, wherein f2 is in the range: (i) <0.5 MHz; (ii) 0.5-1.0 MHz; (iii) 1.0-1.5 MHz; (iv) 1.5-2.0 MHz; (v) 2.0-2.5 MHz; (vi) 2.5-3.0 MHz; (vii) 3.0-3.5 MHz; (viii) 3.5-4.0 MHz; or (ix) >4.0 MHz.

10. An electronic circuit as claimed in claim 6, wherein the one or more induction elements comprise one or more induction coils.

11. An aerosol provision device comprising:
an electronic circuit as claimed in claim 6.

12. An aerosol provision device as claimed in claim 11, further comprising an aerosol generator.

13. An aerosol provision device as claimed in claim 12, wherein the aerosol generator comprises one or more induction elements.

14. An aerosol provision device as claimed in claim 13, wherein the one or more induction elements comprise one or more induction coils.

15. An aerosol generating system comprising:
an aerosol provision device as claimed in claim 11; and
an aerosol generating article comprising aerosol generating material.

16. A method of generating an aerosol comprising:
providing an aerosol provision device as claimed in claim 11;
inserting an aerosol generating article comprising aerosol generating material into the aerosol provision device; and
energizing the aerosol provision device in order to generate aerosol from the aerosol generating material.
